(19) United States
(12) Patent Application Publication
(10) Pub. No.: US 2024/0080240 A1
(43) Pub. Date: Mar. 7, 2024

(54) ELECTRONIC DEVICE, SYSTEM, AND CONTROL METHOD FOR ELECTRONIC DEVICE

(71) Applicant: Panasonic Intellectual Property Management Co., Ltd., Osaka (JP)

(72) Inventors: Mitsuyoshi MATSUMOTO, Osaka (JP); Akira AMANO, Osaka (JP); Miyu MIYAJIMA, Osaka (JP)

(73) Assignee: Panasonic Intellectual Property Management Co., Ltd., Osaka (JP)

(21) Appl. No.: 18/388,816

(22) Filed: Nov. 11, 2023

Related U.S. Application Data
(63) Continuation of application No. PCT/JP2022/018660, filed on Apr. 25, 2022.

(30) Foreign Application Priority Data
May 25, 2021 (JP) 2021-087773

(51) Int. Cl. H04L 41/0866; H04L 67/1095

(52) U.S. Cl. CPC H04L 41/0866; H04L 67/1095

(57) ABSTRACT

An electronic device includes: a communication device configured to communicate with a server device that provides data; a storage device; and a control device that cyclically accesses the server device using the communication device to check whether or not new data has been provided from the server device, determines, based on a predetermined probability, whether to download the new data from the server device or to postpone download when the new data has been provided, and stores, in the storage device, the new data downloaded from the server device.

### BACKGROUND

### 1. Technical Field

The present disclosure relates to an electronic device, a system, and a control method for an electronic device.

### 2. Description of the Related Art

In a system including a server device and a plurality of client devices connected to each other via a communication line, data may be periodically downloaded and/or uploaded. In a case where the size of a file to be downloaded or uploaded is very large, and in a case where there are a large number of client devices, a large load is applied to the server device and the communication line. In general, the server device controls each client device so as to temporally distribute download or upload of each client device, whereby concentration of load on the server device and the communication line can be reduced.

For example, Patent Literature (PTL) 1 discloses a data file automatic collection system that controls sending of a data file stored in a client device to a file collection server based on a file collection schedule created by the file collection server.

PTL 1 is Unexamined Japanese Patent Publication No. 2005-275846.

### SUMMARY

In a case where the server device cannot control client devices or the client devices cannot cooperate with one another, such as a case where a very large number of client devices exist, concentration of the load on the server device and the communication line needs to be reduced by the operation of only the client devices.

For example, in a case where the server device periodically provides data for each client device, it is conceivable to set each client device so as to access the server device on a predetermined day of the week in order to temporally distribute access from each client device to the server device. However, when the client device is a personal computer used in, for example, an office of a company, the client device is started up only on work days, and is not started up on non-work days. Therefore, in order to check the presence or absence of new data to download, the client device accesses the server device only on a work day and does not access the server device on a non-work day. In this case, if the client device is not started up on the day of the week set to access the server device due to consecutive non-work days or the like, each client device accesses the server device on the first work day after the consecutive non-work days, and thus, there is a risk that download of data will concentrate. Therefore, when each client device downloads data from the server device, it is required to reduce the concentration of load on the server device and the communication line due to holidays, non-work days, or the like.

The present disclosure provides an electronic device that is a client device capable of communicating with a server device, the electronic device being capable of downloading data from the server device while reducing concentration of a load on the server device and a communication line due to a holiday, a non-work day, or the like. The present disclosure also provides a system including such at least one electronic device and a server device. The present disclosure also provides a control method for such electronic device.

An electronic device according to one aspect of the present disclosure includes a communication device, a storage device, and a control device. The communication device is connected to and communicates with a server device that provides data. The control device cyclically accesses the server device using the communication device to check whether or not new data has been provided from the server device. When new data has been provided, the control device determines, based on a predetermined probability, whether to download the new data from the server device or to postpone download. The control device stores, in the storage device, the new data downloaded from the server device.

According to an electronic device of one aspect of the present disclosure, it is possible to download data from the server device while reducing concentration of a load on the server device and a communication line due to a holiday, a non-work day, or the like.

### BRIEF DESCRIPTION OF THE DRAWINGS

FIG. 1 is a schematic diagram illustrating a configuration of a system including server device 1 and electronic device 2 according to an exemplary embodiment.

FIG. 2 is a block diagram illustrating a configuration of server device 1 of FIG. 1.

FIG. 3 is a block diagram illustrating a configuration of electronic device 2 of FIG. 1.

FIG. 4 is a first part of a flowchart showing update management processing executed by control device 21 of electronic device 2 of FIG. 3.

FIG. 5 is a second part of a flowchart showing the update management processing executed by control device 21 of electronic device 2 of FIG. 3.

FIG. 6 is a view illustrating an example of access from each electronic device 2 to server device 1 in a system according to a first comparative example.

FIG. 7 is a view illustrating an example of access from each electronic device 2 to server device 1 in a system according to a second comparative example.

FIG. 8 is a view illustrating an example of access from each electronic device 2 to server device 1 and download of data in the system according to the exemplary embodiment.

FIG. 9 is a graph showing an example of a temporal change in the number of times of download in the system according to the exemplary embodiment.

FIG. 10 is a graph showing another example of a temporal change in the number of times of download in the system according to the exemplary embodiment.

### DETAILED DESCRIPTION

Exemplary embodiments will now be described below in detail with reference to the drawings as appropriate. However, unnecessarily detailed description may be omitted. For example, the detailed description of already well-known matters and the overlap description of approximately the same configurations may not be described. This is to avoid an unnecessarily redundant description below and to facilitate understanding by those skilled in the art.

Note that the inventors of the present disclosure provide the accompanying drawings and the following description for those skilled in the art to fully understand the present disclosure, and do not provide them to intend to limit the subject matter described in the scope of claims.

### EXEMPLARY EMBODIMENT

### Configuration of Exemplary Embodiment

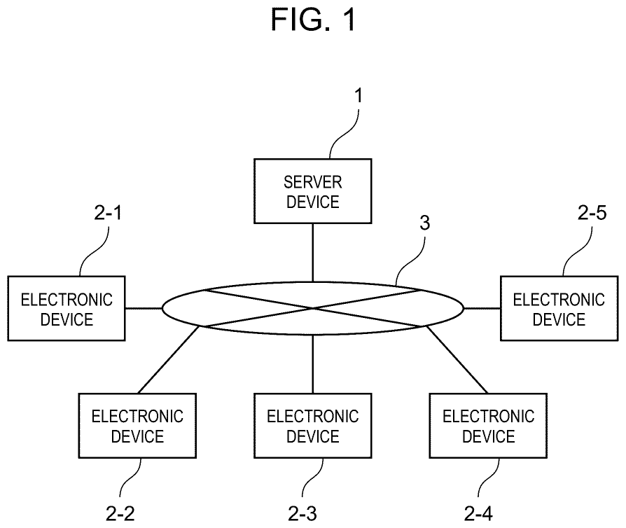

FIG. 1 is a schematic diagram illustrating the configuration of a system including server device 1 and electronic device 2 according to an exemplary embodiment. The system of FIG. 1 includes server device 1 and electronic devices 2-1 to 2-5 connected to one another via communication line 3.

In the present description, electronic devices 2-1 to 2-5 are also collectively called “electronic device 2”.

Server device 1 periodically provides data for each electronic device 2. The data for each electronic device 2 includes an update program of an application program installed in electronic device 2, for example. The data for each electronic device 2 may include, for example, video data, audio data, and text data. Server device 1 includes, for example, a general-purpose computer. In the present description, as an example, a case where server device 1 periodically provides new data for each electronic device 2, that is, update data will be described.

Each electronic device 2 accesses server device 1 via communication line 3 and downloads update data from server device 1. Each electronic device 2 includes, for example, a personal computer or a mobile phone.

Communication line 3 includes a wired or wireless network, for example, the Internet or a mobile phone network.

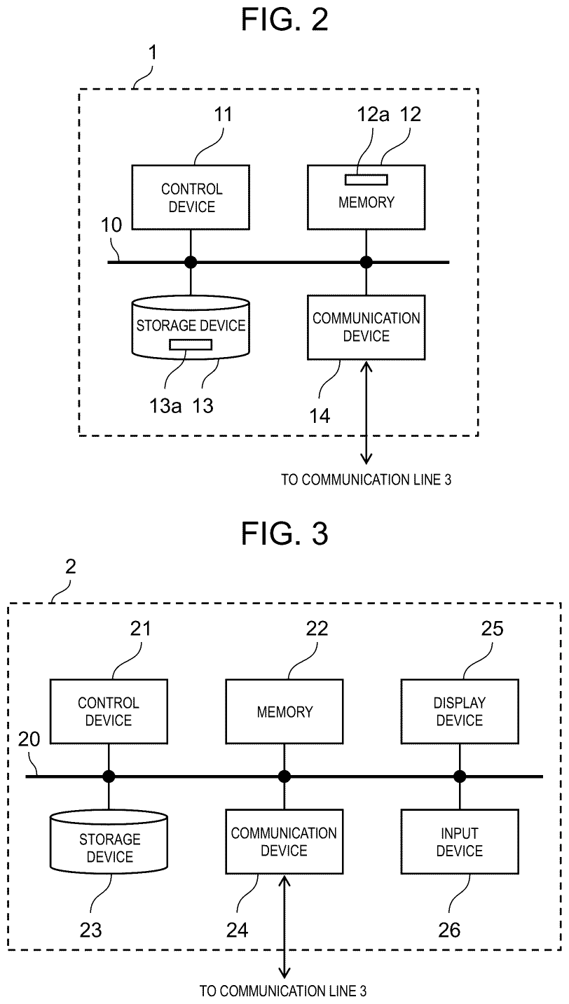

FIG. 2 is a block diagram illustrating the configuration of server device 1 of FIG. 1. Server device 1 includes bus 10, control device 11, memory 12, storage device 13, and communication device 14. Control device 11 controls the operation of entire server device 1, and provides update data 13a (described later) stored in storage device 13 to electronic device 2 in response to a request from each electronic device 2. Control device 11 includes, for example, a CPU. Memory 12 temporarily stores a program and data necessary for the operation of server device 1. The data necessary for the operation of server device 1 includes, for example, update management file 12a indicating a file name, a time stamp, a file size, and the like of update data 13a stored in storage device 13. Storage device 13 is a nonvolatile storage medium that stores a program necessary for the operation of server device 1 and stores update data 13a for each electronic device 2. Communication device 14 is communicably connected to each electronic device 2 via communication line 3. Control device 11, memory 12, storage device 13, and communication device 14 are connected to one another via bus 10.

FIG. 3 is a block diagram illustrating the configuration of electronic device 2 of FIG. 1. Electronic device 2 includes bus 20, control device 21, memory 22, storage device 23, communication device 24, display device 25, and input device 26. Control device 21 controls the operation of entire electronic device 2. Memory 22 temporarily stores a program and data necessary for the operation of server device 1. Storage device 23 is a nonvolatile storage medium that stores a program necessary for the operation of electronic device 2 and stores update data 13a downloaded from server device 1. Communication device 24 is communicably connected to server device 1 via communication line 3. Display device 25 displays the state of electronic device 2. Input device 26 receives user input for controlling the operation of electronic device 2. Input device 26 includes, for example, a keyboard and a pointing device. Control device 21, memory 22, storage device 23, communication device 24, display device 25, and input device 26 are connected to one another via bus 20.

Control device 21 cyclically accesses server device 1 using communication device 24 to check whether or not new update data 13a has been provided. When new update data 13a has been provided, control device 21 determines, based on predetermined probability Pr, whether to download new update data 13a from server device 1 or to postpone download. Control device 21 stores, in storage device 23, new update data 13a downloaded from server device 1.

Control device 21 may access server device 1, for example, every 7 days using communication device 24 in order to check whether or not new update data 13a has been provided.

In a case where new update data 13a has been provided and in a case of determining to postpone the download of new update data 13a based on probability Pr, control device 21 may increase probability Pr. Thereafter, control device 21 redetermines, based on increased probability Pr, after a lapse of a predetermined time length, whether to download new update data 13a from server device 1 or to postpone download.

In a case where new update data 13a has been provided and in a case of determining to postpone the download of new update data 13a based on probability Pr, after a lapse of a predetermined random time length, control device 21 may redetermine whether to download new update data 13a from server device 1 or to postpone download based on probability Pr.

After a lapse of a predetermined random time length from start-up of electronic device 2, control device 21 may cyclically access server device 1 using communication device 24 to check whether or not new update data 13a has been provided.

### Operation of Exemplary Embodiment

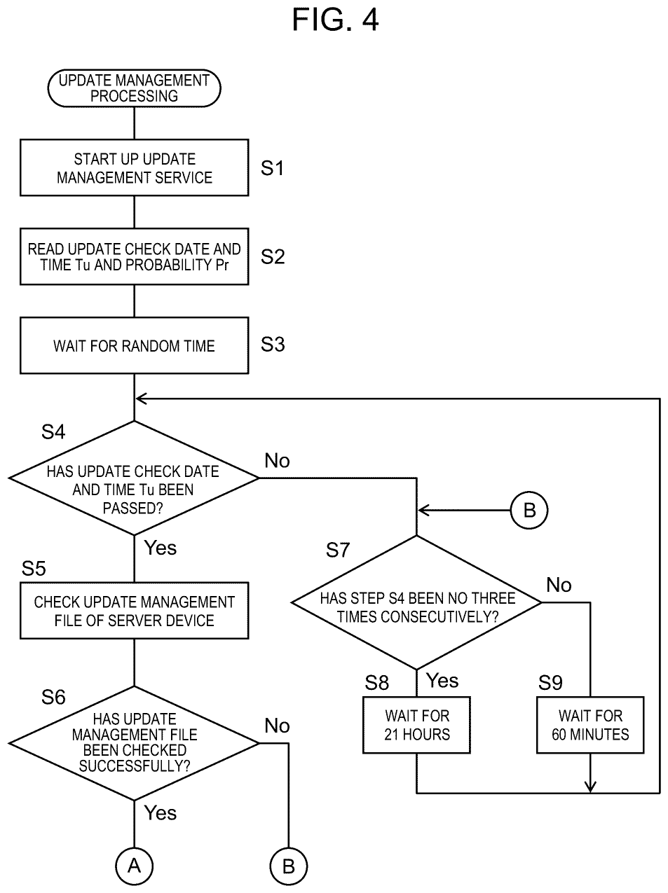

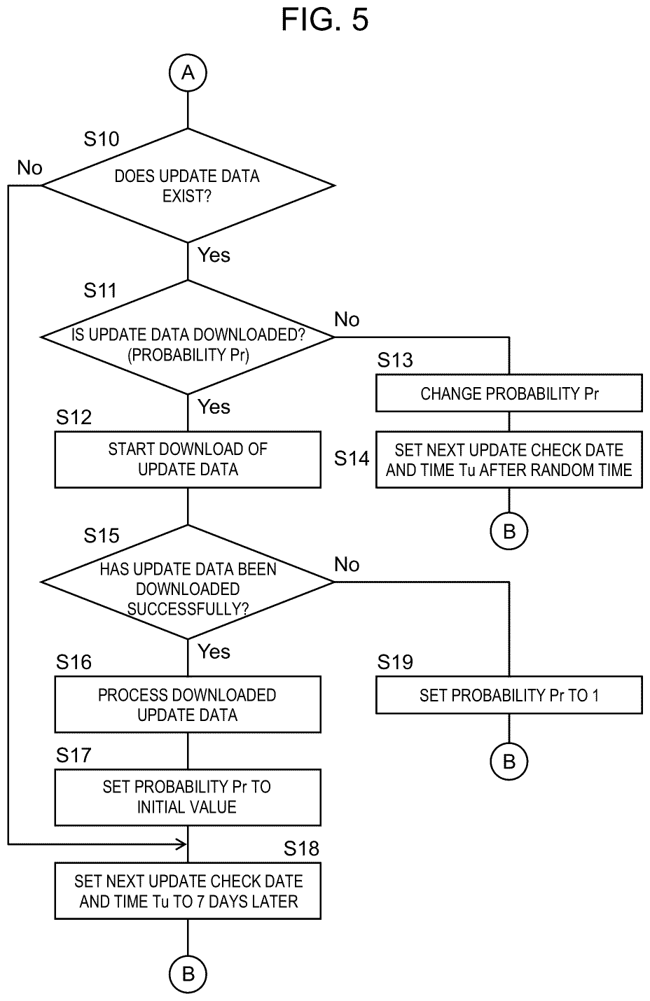

FIG. 4 is the first part of the flowchart showing the update management processing executed by control device 21 of electronic device 2 of FIG. 3. FIG. 5 is the second part of the flowchart showing the update management processing executed by control device 21 of electronic device 2 of FIG. 3.

After the start-up of electronic device 2, in step S1 of FIG. 4, control device 21 automatically starts up an update management service.

In step S2, control device 21 reads update check date and time Tu and probability Pr from storage device 23 (or another nonvolatile storage medium). Update check date and time Tu indicates a date and time set to access server device 1 in order to check the presence or absence of new update data 13a to download. Probability Pr indicates a probability of determining to download update data 13a in step S11 of FIG. 5 described later. In a case of executing the update management processing first after setup of electronic device 2, control device 21 may randomly set the initial value of update check date and time Tu to, for example, any of 0 days to 6 days after the current time, and may set the initial value of probability Pr to, for example, ⅛. On the other hand, in a case of executing the update management processing for the second and subsequent times, control device 21 reads, from storage device 23 (or another nonvolatile storage medium), update check date and time Tu and probability Pr set at the time of previous execution of the update management processing.

In step S3, control device 21 waits for a random time length, for example, an arbitrary time length of 0 minutes to 300 minutes.

In step S4, control device 21 determines whether or not the current time has passed update check date and time Tu. When YES, the process proceeds to step S5, and when NO, the process proceeds to step S7.

In step S5, control device 21 checks update management file 12a of server device 1 in order to check whether or not new update data 13a has been provided. In step S6, control device 21 determines whether or not to have successfully checked update management file 12a. When YES, the process proceeds to step S10 of FIG. 5, and when NO, the process proceeds to step S7 of FIG. 4.

In step S7, control device 21 determines whether or not the determination in step S4 has been NO three times consecutively. When YES, the process proceeds to step S8, and when NO, the process proceeds to step S9. In step S8, control device 21 waits for 21 hours, and returns to step S4. In step S9, control device 21 waits for 60 minutes, and returns to step S4.

In step S10 of FIG. 5, control device 21 determines, based on update management file 12a, whether or not new update data 13a exists in server device 1. When YES, the process proceeds to step S11 and when NO, the process proceeds to step S18.

In step S11, control device 21 determines, based on probability Pr, whether or not to download update data 13a from server device 1. When YES, the process proceeds to step S12, and when NO, the process proceeds to step S13. In other words, in step S11, control device 21 determines, based on probability Pr, whether to immediately download update data 13a from server device 1 or to postpone download. Here, “immediately download” means to start the download of update data 13a without waiting time, or to start the download of update data 13a within a predetermined time period, for example, within 24 hours.

In step S12, control device 21 starts download of update data 13a.

In step S13, control device 21 changes probability Pr. For example, when the initial value of probability Pr is ⅛, control device 21 may change probability Pr in the order of ⅛→ 1/7→⅙→⅕→¼→⅓→½→1/1 every time it is determined to be NO in step S11. In step S14, control device 21 sets next update check date and time Tu after a random time, for example, any of 1 day to 7 days after the current time. After the execution of steps S13 and S14, the process returns to step S7 of FIG. 4.

In step S15, control device 21 determines whether or not the download of update data 13a is successful. When YES, the process proceeds to step S16, and when NO, the process proceeds to step S19.

In step S16, control device 21 processes downloaded update data 13a. When update data 13a is an update program of an application program, control device 21 applies the update program. In a case where update data 13a is video data, control device 21 may display the video data on display device 25, and may store the video data in storage device 23 for later display.

In step S17, control device 21 sets probability Pr to the initial value, for example, ⅛. In step S18, control device 21 sets next update check date and time Tu to 7 days later. After the execution of step S18, the process returns to step S7 of FIG. 4.

In step S19, control device 21 sets probability Pr to 1. Due to this, when step S11 is executed next, it is determined that update data 13a will always be downloaded from server device 1. After the execution of step S19, the process returns to step S7 of FIG. 4.

Control device 21 stores probability Pr in storage device 23 (or another nonvolatile storage medium) every time control device 21 sets probability Pr in steps S13, S17, and S19. Control device 21 stores update check date and time Tu in storage device 23 (or another nonvolatile storage medium) every time control device 21 sets update check date and time Tu in steps S14 and S18. Due to this, in a case where the update management processing is interrupted due to shutdown of electronic device 2 or the like, when starting up electronic device 2 next, control device 21 can read update check date and time Tu and probability Pr set before the interruption from storage device 23 (or another nonvolatile storage medium) and resume the processing.

As described above, according to the update management processing of FIGS. 4 and 5, each electronic device 2 cyclically accesses server device 1 to check whether or not new update data 13a has been provided. When new update data has been provided, each electronic device 2 determines, based on probability Pr, whether to immediately download new update data 13a from server device 1 or to postpone download. When determining to postpone the download of new update data 13a based on probability Pr, each electronic device 2 increases probability Pr. After a lapse of a predetermined random time length, each electronic device 2 redetermines, based on increased probability Pr, whether to immediately download new update data 13a from server device 1 or to postpone download. Due to this, even when a large number of electronic devices 2 exist, by reducing the concentration of load on server device 1 and communication line 3 due to a holiday, a non-work day, or the like, each electronic device 2 can download update data 13a from server device 1.

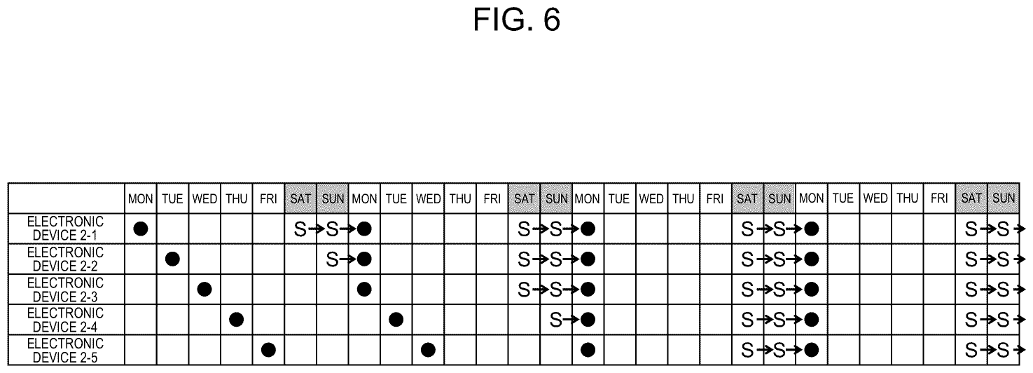

Next, an operation example of the system according to the exemplary embodiment will be described with reference to FIGS. 6 to 8.

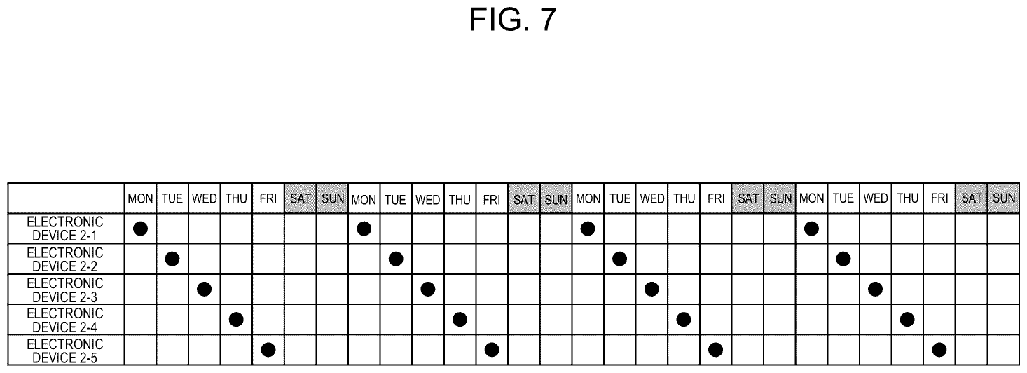

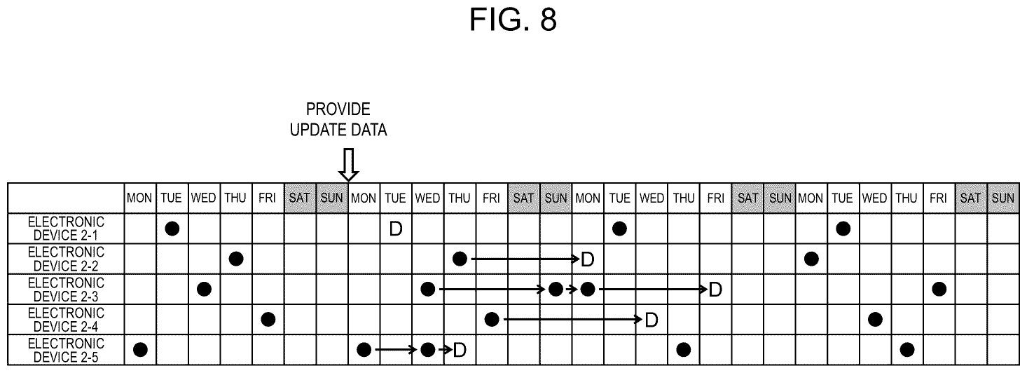

FIG. 6 is a view illustrating an example of access from each electronic device 2 to server device 1 in the system according to the first comparative example. FIG. 6 illustrates a case where each electronic device 2 of FIG. 1 does not execute the update management processing of FIGS. 4 and 5, and a case where each electronic device 2 is set to access server device 1 every five days in the initial state in order to check the presence or absence of new update data to download. In FIG. 6 (and FIGS. 7 and 8), black circles indicate that each electronic device 2 accesses server device 1 in order to check the presence or absence of new update data to download. In FIG. 6 (and FIGS. 7 to 8), “S” indicates that the access from electronic device 2 to server device 1 is skipped although having been set as update check date and time Tu of each electronic device 2. When update check date and time Tu is set to Saturday or Sunday, since electronic device 2 is not started up on non-work days, electronic device 2 does not access server device 1, and accesses server device 1 on the next first work day, that is, Monday. According to FIG. 6, in the initial state, the access from electronic device 2 to server device 1 is distributed to each day of the week of Monday to Friday. However, since Saturday and Sunday are non-work days, as time elapses, access from electronic device 2 to server device 1 concentrates on Monday.

FIG. 7 is a view illustrating an example of access from each electronic device 2 to server device 1 in the system according to the second comparative example. FIG. 7 illustrates a case where each electronic device 2 of FIG. 1 does not execute the update management processing of FIGS. 4 and 5, and a case where each electronic device 2 is set to access server device 1 every 7 days in the initial state in order to check the presence or absence of new update data to download. In a case where each electronic device 2 accesses server device 1 every 7 days, update check date and time Tu is not set to Saturday or Sunday, basically. However, in a case where the access from electronic device 2 to server device 1 is unevenly distributed in the initial state, this unevenness will be permanently maintained. There is a possibility that update check date and time Tu deviates due to a holiday or another vacation, and uniformity of access from electronic device 2 to server device 1 is impaired.

FIG. 8 is a view illustrating an example of access from each electronic device 2 to server device 1 and download of data in the system according to the exemplary embodiment. FIG. 8 illustrates a case where each electronic device 2 of FIG. 1 executes the update management processing of FIGS. 4 and 5, and a case where each electronic device 2 is set to access server device 1 every 7 days in the initial state in order to check the presence or absence of new update data to download. FIG. 8 illustrates a case where server device 1 provides new update data 13a on Monday of the second week. In FIG. 8, “D” indicates that each electronic device 2 downloads update data 13a from server device 1.

As illustrated in the first week to the second week in FIG. 8, each electronic device 2 cyclically accesses server device 1 to check whether or not new update data 13a has been provided.

As illustrated in the second week to the third week of FIG. 8, each electronic device 2 probabilistically determines whether to immediately download new update data 13a from server device 1 or to postpone download. In the example of FIG. 8, electronic device 2-1 immediately downloads new update data 13a from server device 1 at first update check date and time Tu after update data 13a has been provided. On the other hand, other electronic devices 2-2 to 2-5 download new update data 13a from server device 1 at second to fourth update check dates and times Tu after update data 13a has been provided.

As illustrated in the second week to the third week of FIG. 8, when determining to postpone the download of new update data 13a, after a lapse of a random time length, electronic devices 2-2 to 2-5 redetermine whether to immediately download new update data 13a from server device 1 or to postpone download. In the example of FIG. 8, when determining to postpone the download of new update data 13a, electronic devices 2-2 to 2-5 set next update check date and time Tu to 1 day to 5 days later.

As illustrated in the third week to the fourth week in FIG. 8, after downloading update data 13a, each electronic device 2 cyclically accesses server device 1 to check whether or not new update data 13a has been provided.

In a case where the cycle in which each electronic device 2 accesses server device 1 is set to less than or equal to 6 days, since a non-work day exists in one week, similarly to the case of FIG. 6, access from electronic device 2 to server device 1 may concentrate on Monday. On the other hand, in a case where the cycle in which each electronic device 2 accesses server device 1 is set to more than or equal to 8 days, the distribution degree of access is similar to that in a case where the access cycle is set to 7 days.

In the case where the access from electronic device 2 to server device 1 is unevenly distributed in the initial state, this unevenness will be permanently maintained, only by simply cyclically accessing server device 1 and downloading update data 13a. Only by simply cyclically accessing server device 1 and downloading update data 13a, there is a possibility that update check date and time Tu deviates due to a holiday or another vacation, and uniformity of access from electronic device 2 to server device 1 is impaired. On the other hand, by probabilistically determining whether to immediately download new update data 13a or to postpone download, it is possible to reduce the unevenness of the access at all times and to make the concentration of the load on server device 1 and communication line 3 less likely to occur.

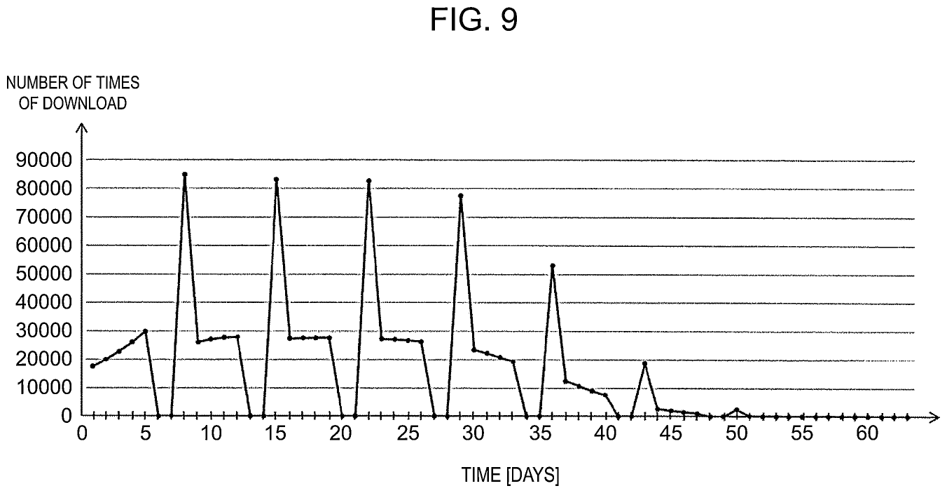

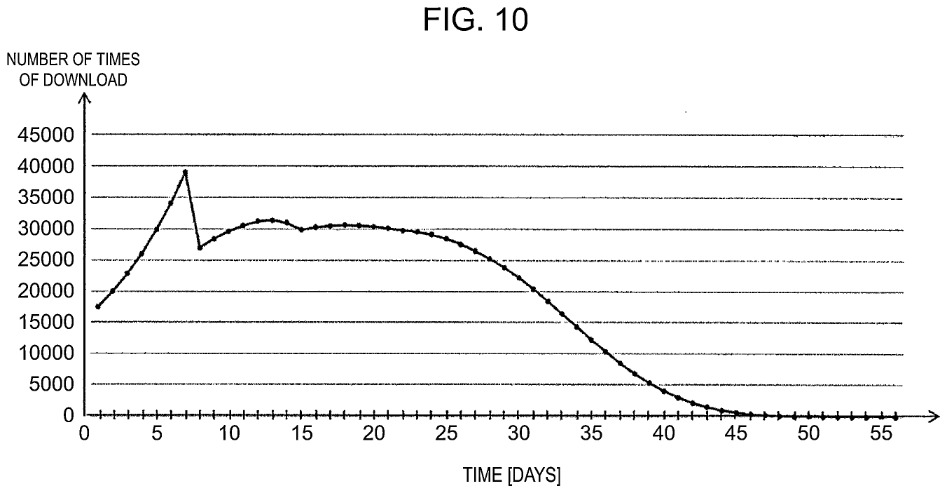

Next, effects of the system according to the exemplary embodiment will be described with reference to FIGS. 9 and 10. FIGS. 9 and 10 illustrate a case where 1 million electronic devices 2 download update data 13a from server device 1. FIGS. 9 and 10 illustrate a case where the initial value of probability Pr is set to ⅛, and probability Pr is changed in the order of ⅛→ 1/7→ . . . ½→1/1 every time it is determined to postpone the download of new update data 13a.

FIG. 9 is a graph showing an example of a temporal change in the number of times of download in the system according to the exemplary embodiment. FIG. 9 illustrates a case where each electronic device 2 is started up only on weekdays, and each electronic device 2 is not started up on Saturdays and Sundays. According to FIG. 9, it can be found that update data 13a is not downloaded on Saturday and Sunday, and as a result, the number of times of download increases on Monday as compared with Tuesday to Friday. However, the peak value of the number of times of download is about 85000 times/day at a maximum, which is sufficiently low as compared with the number of electronic devices 2, and it can be said that the concentration of the load on server device 1 and communication line 3 is reduced.

FIG. 10 is a graph showing another example of a temporal change in the number of times of download in the system according to the exemplary embodiment. FIG. 10 shows a case where each electronic device 2 is started up also on Saturday and Sunday. According to FIG. 10, the peak value of the number of times of download times is about 40000 times/day at a maximum, and it can be said that the concentration of the load on server device 1 and communication line 3 is reduced.

Time length Td required from when server device 1 starts providing update data 13a to when all electronic devices 2 complete the download of update data 13a is determined in consideration of the performance of server device 1, the capacity of communication line 3, the size of the update data, and the like. Assume that the initial value of probability Pr is 1/x (x is an integer). Every time it is determined to postpone the download of new update data 13a, probability Pr is changed in the order of 1/x→1/(x−1)→ . . . →½→1/1. In order to check whether or not new update data 13a has been provided, each electronic device 2 accesses server device 1 every y days. In this case, time length Td is given by Td=(x×y)+1. By appropriately setting parameters x and y, it is possible to set appropriate time length Td in accordance with the performance of server device 1, the capacity of communication line 3, the size of the update data, and the like.

According to electronic device 2 according to the exemplary embodiment, when determining to postpone the download of new update data 13a, after a lapse of a predetermined random time length, electronic device 2 redetermines whether to immediately download new update data 13a from server device 1 or to postpone download. Therefore, it is possible to reduce the concentration of the load on server device 1 and communication line 3 on the first work day after consecutive non-work days, for example. According to electronic device 2 according to the exemplary embodiment, by adjusting the initial value 1/x of probability Pr, it is possible to dynamically adjust the distribution degree of access from electronic device 2 to server device 1. The distribution degree of access has a trade-off relationship with respect to time length Td required until all electronic devices 2 complete the download of update data 13a.

According to electronic device 2 according to the exemplary embodiment, it is possible to reduce the concentration of the load on server device 1 and communication line 3 by only the operation of electronic device 2, for example, by only executing a program of the update management processing of FIGS. 4 and 5 in electronic device 2.

According to electronic device 2 according to the exemplary embodiment, since information such as a day of the week and a non-work day is not necessary, calendar data of each country or localization for each country is not necessary.

### Effects of Exemplary Embodiment

Electronic device 2 according to one aspect of the present disclosure includes communication device 24, storage device 23, and control device 21. Communication device 24 is communicably connected to server device 1 that provides data. Control device 21 cyclically accesses server device 1 using communication device 24 to check whether or not new data has been provided from server device 1. When the new data has been provided, control device 21 determines, based on predetermined probability Pr, whether to download the new data from server device 1 or to postpone download. Control device 21 stores, in storage device 23, the new data downloaded from server device 1.

Due to this, even when a large number of electronic devices 2 exist, by reducing the concentration of load on server device 1 and communication line 3 due to a holiday, a non-work day, or the like, each electronic device 2 can download update data 13a from server device 1.

In electronic device 2 according to one aspect of the present disclosure, control device 21 may access server device 1 every 7 days using communication device 24 to check whether or not the new data has been provided.

Due to this, the possibility that update check date and time Tu is set to Saturday or Sunday can be reduced as compared with the case of accessing server device 1 in a cycle of less than or equal to 6 days.

In electronic device 2 according to one aspect of the present disclosure, when the new data has been provided and control device 21 determines to postpone download of the new data based on probability Pr, control device 21 may increase probability Pr. In this case, after a lapse of a predetermined time length, control device 21 redetermines, based on increased probability Pr, whether to download the new data from server device 1 or to postpone download.

Due to this, probability Pr finally becomes 1, and electronic device 2 can download the update data.

In electronic device 2 according to one aspect of the present disclosure, when the new data has been provided and control device 21 determined to postpone download of the new data based on probability Pr, after a lapse of a first random time length, control device 21 may redetermine, based on probability Pr, whether to download the new data from server device 1 or to postpone download.

Due to this, it is possible to reduce concentration of load on server device 1 and communication line 3.

In electronic device 2 according to one aspect of the present disclosure, after a lapse of a second random time length after starting up electronic device 2, control device 21 may cyclically access server device 1 using communication device 24 to check whether or not the new data has been provided.

Due to this, when start-up of electronic device 2 is concentrated in a certain time zone, it is possible to avoid concentration of access to server device 1 and download of update data 13a at 9:00 AM, for example.

A system according to one aspect of the present disclosure includes at least one electronic device 2 and server device 1 that is communicably connected to each electronic device 2 and provides data.

Due to this, even when a large number of electronic devices 2 exist, by reducing the concentration of load on server device 1 and communication line 3 due to a holiday, a non-work day, or the like, each electronic device 2 can download update data 13a from server device 1.

A control method for electronic device 2 according to one aspect of the present disclosure is a control method for electronic device 2 communicable with server device 1 that provides data, and includes the following steps. The present control method includes cyclically accessing server device 1 to check whether or not new data has been provided from server device 1. The present control method includes determining, based on predetermined probability Pr, whether to download the new data from server device 1 or to postpone download when the new data has been provided. The present control method includes storing, in storage device 23, the new data downloaded from server device 1.

Due to this, even when a large number of electronic devices 2 exist, by reducing the concentration of load on server device 1 and communication line 3 due to a holiday, a non-work day, or the like, each electronic device 2 can download update data 13a from server device 1.

### Other Exemplary Embodiments

The exemplary embodiment has been described as exemplification of the technique disclosed in the present application. However, the technique in the present disclosure is not limited to the exemplary embodiment and is applicable to exemplary embodiments appropriately subjected to changes, replacements, additions, omissions, and the like. It is also possible to combine the components described in the above-described exemplary embodiment to form a new exemplary embodiment.

Thus, hereinafter, other exemplary embodiments are illustrated as examples.

The value of probability Pr is not limited to the case of being changed in the order of ⅛→ 1/7→ . . . →½→1/1, and may be started from another initial value or may be changed to another value.

Server device 1 may dynamically acquire the number of electronic devices 2 and adjust the value of probability Pr so that the number of times of download becomes less than or equal to a certain threshold value. In this case, each electronic device 2 acquires, from server device 1, the value of probability Pr set by server device 1.

As described above, the exemplary embodiments have been described as examples of the technique in the present disclosure. To this end, the accompanying drawings and detailed description have been provided.

Therefore, the components illustrated in the accompanying drawings or described in the detailed description can include not only the components essential for solving the problem but also components not essential for solving the problem in order to exemplify the above technique. For this reason, it should not be immediately construed that those non-essential components are essential only based on the fact that those non-essential components are illustrated in the accompanying drawings or described in the detailed description.

The above-described exemplary embodiments are intended to exemplify the technique in the present disclosure, and thus various changes, replacements, additions, omissions, and the like can be made to the exemplary embodiments within the scope of the claims or equivalents of the claims.

The electronic device, the system, and the control method for the electronic device according to one aspect of the present disclosure are applicable to a case where a server device cannot control each client device so as to distribute the traffic of a communication line or a case where client devices cannot cooperate with one another, such as a case where a very large number of client devices exist. The electronic device that is a client device can distribute the traffic of the communication line.

What is claimed is:

1. An electronic device comprising:
a communication device configured to communicate with a server device that provides data;
a storage device; and
a control device that
cyclically accesses the server device using the communication device to check whether or not new data has been provided from the server device,
determines, based on a predetermined probability, whether to download the new data from the server device or to postpone download when the new data has been provided, and
stores, in the storage device, the new data downloaded from the server device.

2. The electronic device according to claim 1, wherein the control device accesses the server device every 7 days using the communication device to check whether or not the new data has been provided.

3. The electronic device according to claim 1, wherein
when the new data has been provided and the control device determines to postpone download of the new data based on the probability,
the control device
increases the probability, and
after a lapse of a predetermined time length, redetermines, based on the increased probability, whether to download the new data from the server device or to postpone download.

4. The electronic device according to claim 1, wherein
when the new data has been provided and the control device determines to postpone download of the new data based on the probability,
the control device redetermines, after a lapse of a first random time length, based on the probability, whether to download the new data from the server device or to postpone download.

5. The electronic device according to claim 1, wherein after a lapse of a second random time length after starting up the electronic device, the control device cyclically accesses the server device using the communication device to check whether or not the new data has been provided.

6. A system comprising:
the electronic device according to claim 1; and
a server device that is connected to, communicates with, and provides data to the electronic device.

7. A control method for an electronic device configured to communicate with a server device that provides data, the control method comprising:
cyclically accessing the server device to check whether or not new data has been provided from the server device;
determining, based on a predetermined probability, whether to download the new data from the server device or to postpone download when the new data has been provided; and
storing, in a storage device, the new data downloaded from the server device.
